(19) United States
(12) Patent Application Publication
(10) Pub. No.: US 2014/0036052 A1
(43) Pub. Date: Feb. 6, 2014

(54) RING FITTING SYSTEMS

(71) Applicant: SUK MING TERESA LAM, Hong Kong (HK)

(72) Inventor: SUK MING TERESA LAM, Hong Kong (HK)

(21) Appl. No.: 13/563,370

(22) Filed: Jul. 31, 2012

(51) Int. Cl. H04N 7/18

(52) U.S. Cl. 348/77; 348/E07.085

(57) ABSTRACT

A ring fitting system is provided to allow a user to determine if an old ring of the user still fits in the user's finger in terms of shape and size of the finger. In one embodiment, a system is provided, including a scanner, a ring ordering system, a circular housing frame, and a smart camera. A capturing device can be placed onto the frame, wherein the capturing device can be moved freely along the circular frame. A smart camera can be served as the capturing device placing on the circular housing frame. Multiple images of the user's finger can be taken to compare images taken to approximate the size of a ring of the user.

### FIELD OF THE INVENTION

This invention generally relates to fitting users' fingers with rings of right size. Specifically, but not limited to, this invention relates to determining if rings of users can fit in the user's finger in terms of shape and size of the finger.

### BACKGROUND OF THE INVENTION

Ring fitting systems allowing buyers to order rings without human intervention can be highly invaluable. At the present, rings are normally purchased in stores because rings can hardly be bought online because purchasers find it difficult to purchase such items before trying them beforehand. Systems that are able to help fitting sizes of fingers could be commercially beneficial to the jewelry industry as it would open up a new market that can be very sizeable. Moreover, for any individuals sizes of fingers tend to become bigger with ages due to mainly the aging factor. One may often find that a given ring no longer fits in the person's fingers. There is a need to therefore decide if a ring is no longer fitting the user's fingers. And when it happens, it would be helpful if the user is informed regarding how tight the ring is, with respect to the user's fingers.

### SUMMARY OF THE INVENTION

Consistent with embodiments of the invention, a ring fitting system is provided. In one embodiment, the ring fitting system allows a user to determine if an old ring of the user still fits in the user's finger in terms of shape and size of the finger. The system may include a scanner, a ring ordering system, a circular housing frame, and a smart camera.

The scanner can be configured to takes pictures when an object that is laid flat. The object can be a ring belonging to the user or someone other than the user. The object in the picture taken should match the object from where the picture is taken in terms of actual size and dimension

The ring order system may also be included. The order system may be adapted to receive orders from smart devices to produce rings in accordance with specifications included in the received orders.

The circular housing frame, meanwhile, can be configured to capture images of the user's finger. In a further embodiment, the circular housing frame can be made hollowed. More, a capturing device can placed onto the housing frame, wherein the capturing device can be moved freely along the circular frame. In addition, a captured object can be placed at centre of the hollowed housing frame, with the capturing device facing the captured object.

A smart camera may also be included. The smart camera can be used to serve as the capturing device placed on the circular housing frame. The smart camera may include a processing unit and a memory storage configured to capture multiple images of the user's finger. In a specific embodiment, the capturing includes mounting the camera on the circular housing frame, using the camera to take a picture of the finger, moving the camera along the circular housing in an direction that is clockwise, using the camera to take a second picture of the finger to obtain a different side view of the finger, and continuing to move the camera along the rest of the circular housing to take pictures to obtain a set of complete views of the finger.

The captured images may further be analyzed to produce a drawing of the actual shape, size, curvature, and dimension of the user's finger. The scanner would then be used to scan a picture, wherein the scanned picture refers to the ring belonging to the user.

Subsequently, the processor in the smart camera can be used to compute the diameter of the ring from the scanned picture to form a new drawing by superimposing the scanned picture referring to the ring belonging to the user and the drawing showing the actual shape, size, curvature, and dimension of the user's finger. The output would then be displayed as a new drawing to the user after superimposing the scanned picture and the drawing showing the user's finger in order to determine whether fitting problems occur, by comparing the scanned picture of the ring and the drawing showing the user's finger.

### BRIEF DESCRIPTION OF THE DRAWINGS

FIG. 1 illustrates ways to approximate the diameter of a given finger, consistent with an embodiment of the present invention.

FIG. 2 illustrates a ring fitting system, consistent with an embodiment of the present invention.

### DETAILED DESCRIPTION

A ring fitting system is disclosed for allowing a user to determine if an old ring of the user still fits in the user's finger in terms of shape and size of the finger. In one implementation, a scanner is included to allow a picture to be taken on an object that is laid flat. The object is a ring belonging to the user; and the object in the picture taken matches the object from where the picture is taken in terms of actual size and dimension.

What is included also is a ring ordering system adapted to receive orders from smart devices to produce rings in accordance with specifications included in the received orders. The ordering system would work with a smart camera including a processing unit and a memory storage that is configured to capture multiple images of the user's finger; analyze the captured images to produce a drawing of the actual shape, size, curvature, and dimension of the user's finger, from a cross-section standpoint; receive a scanned picture from the scanner. The scanned picture refers to the ring belonging to the user, the scanned picture including the actual size and dimension of the ring to form a new drawing by superimposing the scanned picture referring to the ring belonging to the user and the drawing showing the actual shape, size, curvature, and dimension of the user's finger; display the new drawing to the user, after superimposing the scanned picture and the drawing showing the user's finger; and determine whether fitting problems occur, by comparing the scanned picture of the ring and the drawing showing the user's finger.

A ring ordering system receives orders from smart devices to produce rings in accordance with specifications included in the received orders. A housing frame is incorporated in the system. The housing frame can be designed in various styles or shape. It can be rectangular, triangular, or even circular. In this illustration, a circular housing frame is chosen. The circular frame can be made hollowed, so that a capturing device can be placed onto the frame. The capturing device can be moved freely along the circular frame; and an captured object placed at centre of the hollowed housing frame, with the capturing device facing the captured object. A smart camera, meanwhile, can serve as the capturing device placed on the circular housing frame to capture multiple images of the user's finger.

The camera can be attached freely or mounted on the circular housing frame. The camera can be moved freely along the frame, with the camera facing the finger that is served as the captured object being placed at the centre of the hollowed housing frame, by using the camera to take a picture of the finger, wherein the picture includes a side view of the finger. The camera can be moved along the circular housing in an direction that is clockwise or counterclockwise. After capturing a first picture, the camera can be used to take a second picture of the finger to obtain a different side view of the finger. This process may be continued. The camera may continue to move along the rest of the circular housing to take pictures to obtain a set of complete views of the finger, until the camera has moved back to the full circle. At this time, a number of pictures would have been taken on the user's finger.

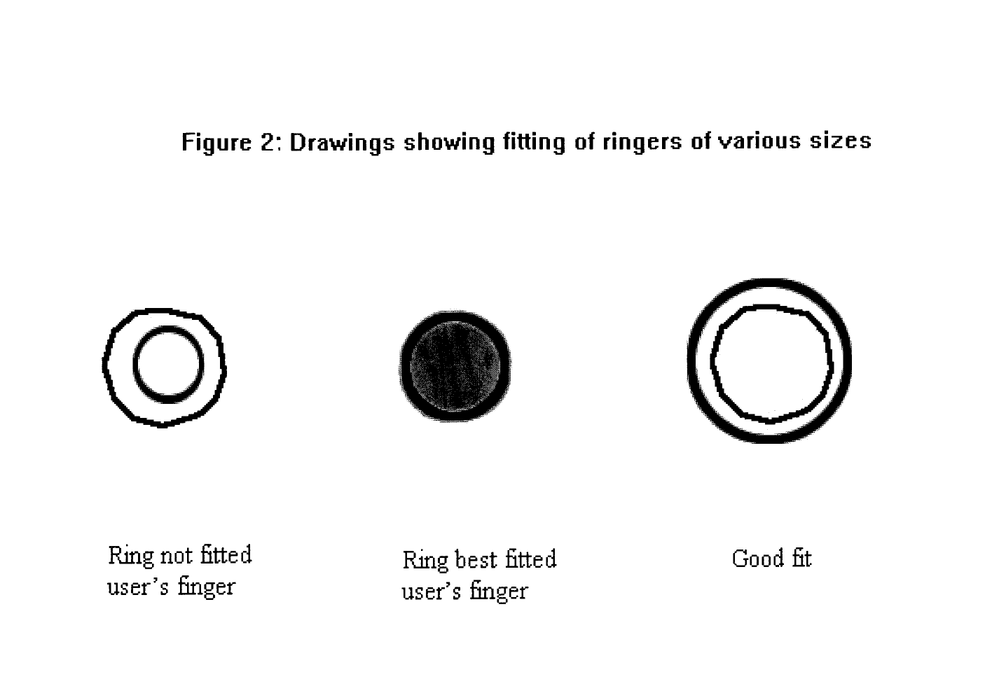

Referring to FIG. 2, the captured images can then be analyzed to produce a drawing of the actual shape, size, curvature, and dimension of the user's finger. To compute the diameter of the ring, a new drawing may by formed by superimposing the scanned picture referring to the ring belonging to the user and the drawing showing the actual shape, size, curvature, and dimension of the user's finger, to display the new drawing to the user. To determine whether fitting problems occur, comparison is performed by comparing the scanned picture of the ring and the drawing showing the user's finger. The ring is regarded as failing to fit the user's finger if the measured diameter of the inner circle of the ring is larger than any one of the measured diameters of the user's finger. However, the ring would be deemed as best fitting the user's finger if the measured diameter of the inner circle of the ring is just as large as the measured diameters of the user's finger. In the process, however, a small margin may be allowed.

In a alternate implementation, a ring fitting system disclosed includes a scanner allowing a picture to be taken on an object that is laid flat, wherein the object is a ring belonging to the user; and the object in the picture taken matches the object from where the picture is taken in terms of actual size and dimension; and a ring ordering system adapted to receive orders from smart devices to produce rings in accordance with specifications included in the received orders.

A circular housing frame may be included, in which the circular housing frame is hollowed. An capturing device can be placed onto the frame, wherein the capturing device can be moved freely along the circular frame; and an captured object can be placed at centre of the hollowed housing frame, with the capturing device facing the captured object; and a smart camera serving as the capturing device placed on the circular housing frame, and including a processing unit and a memory storage that is configured to capture twelve images of the user's finger, wherein the capturing includes mounting the camera on the circular housing frame, wherein the camera can be moved freely along the frame, with the camera facing the finger that is served as the captured object being placed at the centre of the hollowed housing frame; using the camera to take a picture of the finger, wherein the picture includes a side view of the finger; moving the camera along the circular housing in an direction that is 30 degrees clockwise.

After moving the camera to a different angle, the camera is positioned to take a second picture of the finger to obtain a different side view of the finger; and continuing to move the camera along the rest of the circular housing to take pictures to obtain a set of complete views of the finger, until the camera has moved back to the full circle, wherein by then a total number of twelve pictures showing side views of the user's finger have been taken; analyze the twelve captured images to produce a drawing of the actual shape, size, curvature, and dimension of the user's finger, from a cross-section standpoint, wherein the analysis includes from each of the side views of the user's finger included in the pictures taken from the camera, measuring the width of an end of the user's finger.

The end of the user's finger is usually where the ring is fitted. Each of the width of the end shown in each picture refers to a diameter of the user's finger, from a cross-section point of view; calculating a mean from all the twelve measured diameters to represent the mean of the user's finger, from a cross-section point of view; calculating a standard deviation from all the twelve measured diameters to represent the standard deviation of the user's finger, from a cross-section point of view; and by incorporating the mean and the standard deviation, forming a drawing that indicates an actual shape, size, curvature, and dimension of the user's finger from a cross-section perspective, wherein contour of the finger in the drawing is a circular shape, from a cross-section point of view; and sending the drawing to the ordering system via a remote network, wherein the drawing is regarded as a tight fitting of the user's finger.

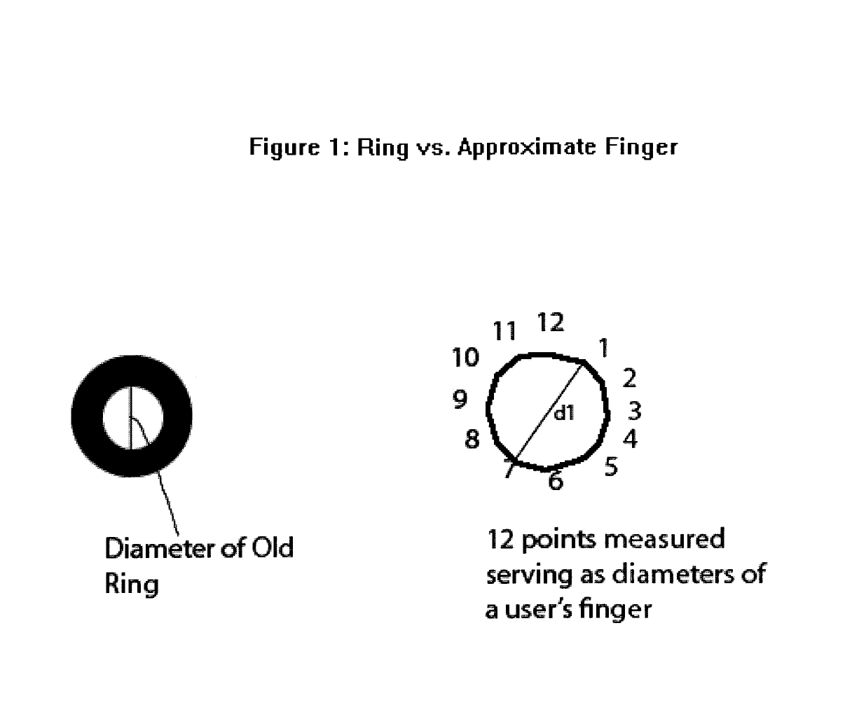

It is mentioned that the housing frame can be made hollow, in order to have an capturing device can be placed onto the frame, so that the capturing device can be moved freely along the frame. An captured object here can be placed at centre of the hollowed housing frame, with the capturing device facing the captured object. Also, The smart camera serving as the capturing device placed on the housing frame can capture twelve images of the user's finger, by mounting the camera on the circular housing frame, wherein the camera can be moved freely along the frame, with the camera facing the finger that is served as the captured object being placed at the centre of the hollowed housing frame; using the camera to take a picture of the finger, wherein the picture includes a side view of the finger; and moving the camera along the circular housing in an direction that is 30 degrees clockwise. In one example, the camera can continue to move along the rest of the circular housing to take pictures to obtain a set of complete views of the finger, until the camera has moved back to the full circle, wherein by then a total number of twelve pictures showing side views of the user's finger have been taken. See FIG. 1. The twelve captured images can be used to produce a drawing of the actual shape, size, curvature, and dimension of the user's finger, from a cross-section standpoint. The analysis includes, from each of the side views of the user's finger included in the pictures taken from the camera, measuring the width of an end of the user's finger, wherein the end is where the ring is fitted, and wherein each of the width of the end shown in each picture refers to a diameter of the user's finger, from a cross-section point of view; calculating a mean from all the twelve measured diameters to represent the mean of the user's finger, from a cross-section point of view; calculating a third standard deviation from all the twelve measured diameters to represent the standard deviation of the user's finger, from a cross-section point of view, wherein the third standard deviation represents including 99.7% of all of the twelve measured diameters into consideration; and by incorporating the mean and the third standard deviation, forming a drawing that closely indicates an actual shape, size, curvature, and dimension of the user's finger from a cross-section perspective, wherein contour of the finger in the drawing is a circular shape, from a cross-section point of view; and sending the drawing to the ordering system via a remote network, wherein the drawing is regarded as a best fitting of the user's finger

What is claimed is:

1. A ring fitting system for allowing a user to determine if an old ring of the user still fits in the user's finger in terms of shape and size of the finger, comprising:
a scanner allowing a picture to be taken on an object that is laid flat, wherein:
the object is a ring belonging to the user; and
the object in the picture taken matches the object from where the picture is taken in terms of actual size and dimension;
a ring ordering system adapted to receive orders from smart devices to produce rings in accordance with specifications included in the received orders;
a circular housing frame, wherein:
the circular housing frame is hollowed;
an capturing device placed onto the frame, wherein the capturing device can be moved freely along the circular frame; and
an captured object placed at centre of the hollowed housing frame, with the capturing device facing the captured object; and
a smart camera serving as the capturing device placed on the circular housing frame, and including a processing unit and a memory storage that is configured to:
capture multiple images of the user's finger, wherein the capturing includes:
mounting the camera on the circular housing frame, wherein the camera can be moved freely along the frame, with the camera facing the finger that is served as the captured object being placed at the centre of the hollowed housing frame;
using the camera to take a picture of the finger, wherein the picture includes a side view of the finger;
moving the camera along the circular housing in an direction that is clockwise;
after moving the camera, using the camera to take a second picture of the finger to obtain a different side view of the finger; and
continuing to move the camera along the rest of the circular housing to take pictures to obtain a set of complete views of the finger, until the camera has moved back to the full circle, wherein by then a number of pictures have been taken on the user's finger;
analyze the captured images to produce a drawing of the actual shape, size, curvature, and dimension of the user's finger;
receive a scanned picture from the scanner, wherein the scanned picture refers to the ring belonging to the user, the scanned picture including the actual size and dimension of the ring;
compute, from the scanned picture, the diameter of the ring;
form a new drawing by superimposing the scanned picture referring to the ring belonging to the user and the drawing showing the actual shape, size, curvature, and dimension of the user's finger;
display the new drawing to the user, after superimposing the scanned picture and the drawing showing the user's finger; and
determine whether fitting problems occur, by comparing the scanned picture of the ring and the drawing showing the user's finger.

2. The system of claim 1, wherein the ring is regarded as failing to fit the user's finger if the measured diameter of the inner circle of the ring is larger than any one of the measured diameters of the user's finger.

3. The system of claim 1, wherein the analyzing the twelve captured images to produce a drawing of the actual shape, size, curvature, and dimension of the user's finger is made from a cross-section standpoint, wherein the analysis includes:
from each of the side views of the user's finger included in the pictures taken from the camera, measuring the width of an end of the user's finger, wherein the end is where the ring is fitted, and wherein each of the width of the end shown in each picture refers to a diameter of the user's finger, from a cross-section point of view; and
from all the measurements of the width serving as the diameters of the user's finger, forming a drawing that indicates an actual shape, size, curvature, and dimension of the user's finger from a cross-section perspective, wherein contour of the finger in the drawing is a non-circular shape, from a cross-section point of view.

4. The system of claim 2, wherein the analyzing the twelve captured images to produce a drawing of the actual shape, size, curvature, and dimension of the user's finger is made from a cross-section standpoint, wherein the analysis includes:
from each of the side views of the user's finger included in the pictures taken from the camera, measuring the width of an end of the user's finger, wherein the end is where the ring is fitted, and wherein each of the width of the end shown in each picture refers to a diameter of the user's finger, from a cross-section point of view; and
from all the measurements of the width serving as the diameters of the user's finger, forming a drawing that indicates an actual shape, size, curvature, and dimension of the user's finger from a cross-section perspective, wherein contour of the finger in the drawing is a non-circular shape, from a cross-section point of view.

5. A ring fitting system allowing a user to send orders remotely to an ordering system without needing to go to stores for tryouts, comprising:
a scanner allowing a picture to be taken on an object that is laid flat, wherein:
the object is a ring belonging to the user; and
the object in the picture taken matches the object from where the picture is taken in terms of actual size and dimension;
a ring ordering system adapted to receive orders from smart devices to produce rings in accordance with specifications included in the received orders;
a circular housing frame, wherein:
the circular housing frame is hollowed;
an capturing device can be placed onto the frame, wherein the capturing device can be moved freely along the circular frame; and
an captured object can be placed at centre of the hollowed housing frame, with the capturing device facing the captured object; and
a smart camera serving as the capturing device placed on the circular housing frame, and including a processing unit and a memory storage that is configured to:
capture twelve images of the user's finger, wherein the capturing includes:
mounting the camera on the circular housing frame, wherein the camera can be moved freely along the frame, with the camera facing the finger that is served as the captured object being placed at the centre of the hollowed housing frame;
using the camera to take a picture of the finger, wherein the picture includes a side view of the finger;
moving the camera along the circular housing in an direction that is 30 degrees clockwise;
after moving the camera, using the camera to take a second picture of the finger to obtain a different side view of the finger; and
continuing to move the camera along the rest of the circular housing to take pictures to obtain a set of complete views of the finger, until the camera has moved back to the full circle, wherein by then a total number of twelve pictures showing side views of the user's finger have been taken;
analyze the twelve captured images to produce a drawing of the actual shape, size, curvature, and dimension of the user's finger, from a cross-section standpoint, wherein the analysis includes:
from each of the side views of the user's finger included in the pictures taken from the camera, measuring the width of an end of the user's finger, wherein the end is where the ring is fitted, and wherein each of the width of the end shown in each picture refers to a diameter of the user's finger, from a cross-section point of view;
calculating a mean from all the twelve measured diameters to represent the mean of the user's finger, from a cross-section point of view;
calculating a standard deviation from all the twelve measured diameters to represent the standard deviation of the user's finger, from a cross-section point of view; and
by incorporating the mean and the standard deviation, forming a drawing that indicates an actual shape, size, curvature, and dimension of the user's finger from a cross-section perspective, wherein contour of the finger in the drawing is a circular shape, from a cross-section point of view; and
sending the drawing to the ordering system via a remote network, wherein the drawing is regarded as a tight fitting of the user's finger.

6. A ring fitting system allowing a user to send orders remotely to an ordering system without needing to go to stores for tryouts, comprising:
a scanner allowing a picture to be taken on an object that is laid flat, wherein:
the object is a ring belonging to the user; and
the object in the picture taken matches the object from where the picture is taken in terms of actual size and dimension;
a ring ordering system adapted to receive orders from smart devices to produce rings in accordance with specifications included in the received orders;
a circular housing frame, wherein:
the circular housing frame is hollowed;
an capturing device can be placed onto the frame, wherein the capturing device can be moved freely along the circular frame; and
an captured object can be placed at centre of the hollowed housing frame, with the capturing device facing the captured object; and
a smart camera serving as the capturing device placed on the circular housing frame, and including a processing unit and a memory storage that is configured to:
capture twelve images of the user's finger, wherein the capturing includes:
mounting the camera on the circular housing frame, wherein the camera can be moved freely along the frame, with the camera facing the finger that is served as the captured object being placed at the centre of the hollowed housing frame;
using the camera to take a picture of the finger, wherein the picture includes a side view of the finger;
moving the camera along the circular housing in an direction that is 30 degrees clockwise;
after moving the camera, using the camera to take a second picture of the finger to obtain a different side view of the finger; and
continuing to move the camera along the rest of the circular housing to take pictures to obtain a set of complete views of the finger, until the camera has moved back to the full circle, wherein by then a total number of twelve pictures showing side views of the user's finger have been taken;
analyze the twelve captured images to produce a drawing of the actual shape, size, curvature, and dimension of the user's finger, from a cross-section standpoint, wherein the analysis includes:
from each of the side views of the user's finger included in the pictures taken from the camera, measuring the width of an end of the user's finger, wherein the end is where the ring is fitted, and wherein each of the width of the end shown in each picture refers to a diameter of the user's finger, from a cross-section point of view;
calculating a mean from all the twelve measured diameters to represent the mean of the user's finger, from a cross-section point of view;
calculating a third standard deviation from all the twelve measured diameters to represent the standard deviation of the user's finger, from a cross-section point of view, wherein the third standard deviation represents including 99.7% of all of the twelve measured diameters into consideration; and
by incorporating the mean and the third standard deviation, forming a drawing that closely indicates an actual shape, size, curvature, and dimension of the user's finger from a cross-section perspective, wherein contour of the finger in the drawing is a circular shape, from a cross-section point of view; and
sending the drawing to the ordering system via a remote network, wherein the drawing is regarded as a best fitting of the user's finger.
